(19) United States
(12) Patent Application Publication
(10) Pub. No.: US 2014/0084671 A1
(43) Pub. Date: Mar. 27, 2014

(54) Bicycle Wheel Structure

(71) Applicant: Shih-Wei Chen, ShenZhen (TW)

(72) Inventor: Shih-Wei Chen, ShenZhen (TW)

(21) Appl. No.: 13/628,041

(22) Filed: Sep. 27, 2012

(51) Int. Cl. B60B 1/02; B60B 1/00

(52) U.S. Cl. CPC B60B 1/0223; B60B 1/003
USPC 301/55

(57) ABSTRACT

A bicycle wheel structure comprises a hub, spoke wires and a rim, wherein the front and back end of the spoke wires are connected to the hub and the rim respectively, wherein: spoke wires are arranged in a group of five spoke wires to form a spoke wire group, wherein each spoke wire group has an interweaving spoke wire ratio of 2:3, and the hub and the rim are connected to at least three groups of the spoke wire group said spoke wire group comprise a fifth spoke wire that works as a force balancing wire for the other four spoke wires, wherein, the first end of the fifth spoke wire is connected to the driving end of the hub, and the second end of the fifth spoke wire is connected to the rim; and said fifth spoke wire is arranged symmetrically in, or near the center of the spoke wire group.

### FIELD OF THE INVENTION

The present invention relates to the field of bicycle technology and particularly relates to a bicycle wheel structure.

### BACKGROUND TECHNOLOGY

With the improvement of people's standard of living, environmental awareness and fitness needs to improve, bicycles, both as a means of transport and as a kind of fitness equipment, is becoming more and more popular nowadays. As bicycles becomes more and more popular, people are also becoming more and more demanding on the quality of bicycles, such as: bike riding comfort, the overall body balance and durability.

In order to meeting these demands, bicycle manufacturers have been developing new technologies that can be used on bicycles to meet these demands. Wherein, many technology improvements have been introduced that focus on bicycle wheels. Typically a bicycle wheel comprises a hub, a rim and spoke wires. The hub and rim are connected together through spoke wires. Typically, spoke wires are arranged in a 1:1 criss-cross ratio connected to the left and right side of the hub. A chain drive mechanism or a brake system is usually arranged on one side of the hub. When working, the chain drive mechanism or brake system exert force to one side of the hub, the same will happen when chain drive mechanism corresponds to the rear wheel, or with the front or rear wheel disc brake system. As with the chain drive mechanism or brake system set up, the two sides of the hub, spoke wires and the rim will receive uneven force resulting in poor balance of bicycle, furthermore, as each spoke wire receives different push and pull force, especially those spoke wires which with receive greater force, in a long term, these spoke wires will wear out sooner than other spoke wires and post a hidden danger for the bicycle user.

To solve these problems, Chinese patent No. 01244882.6 discloses a solution, with a convergent of spoke wires based on a ratio of 1:2 interweaving connected to the left and right sides of the hub. However, this invention does not solve the on going problems with bicycle wheels, more particularly, on the side of hub with more spoke wires connected to it, these spoke wires received less force than those spoke wires on the side of hub with less spoke wires connected to it. As a result, the force exert onto the spoke wires from the hub and rim still not balanced causing premature wear or failure of certain spoke wires.

### SUMMARY OF THE INVENTION

The objective of present invention focus the shortcomings of the prior art to provide a new structure of a bicycle wheel, which provides a good balance of force, and long lasting life characteristics.

In order to achieve the above object, the bicycle wheel structure of present invention comprises a hub, a rim and spoke wires, the ends of the wire are respectively connected to hub and the rim. As a special characteristic of the invention: the spoke wires are grouped in a number of five to form a spoke wire group. In each of the spoke wire group the spoke wire are arranged in a 2:3 interweaving ratio, wherein, the hub and the rim are connected to at least three groups of spoke wire group.

As a preferred arrangement, the hub and the rim are connected to 3˜10 groups of spoke wire group.

As a preferred arrangement, three of the spoke wires from the spoke wire group are connected to the hub on it's driving end, and the other two spoke wires are connected to non-drive end of the hub.

As a preferred arrangement, one of the spoke wires from the spoke wire group is denoted as a fifth spoke wire and it acts as a force balancer for the other four spoke wires in the spoke wire group. The fifth spoke wire is intentionally set in the plane of the axis passing through the hub and the rim.

As a preferred arrangement, the spoke wire group further comprises a first spoke wire mini group and a second spoke wire mini group. The first end of spoke wires in the first spoke wire mini group is attached to the hub and the second is connected to the rim; the first and second spoke wire mini group crosses each other in a X shape; the first end of the fifth spoke wire is arranged in the middle of the first end of first and second spoke wire mini group; and the second end of the fifth spoke wire is arranged in the middle of the second end of first and second spoke wire mini group.

As a preferred arrangement, the first spoke wire mini group comprises a first spoke wire and a second spoke wire. The first end of the first and second spoke wire is connected to the first and second side of hub respectively. The second end of first and second spoke wire is connected to the rim. The second spoke wire mini group comprises a third spoke wire and a fourth spoke wire. The first end of the third and fourth spoke wire is connected to the first and second end of hub respectively. The second end of third and fourth spoke wire is connected to the rim.

As a preferred arrangement, the first spoke wire mini group and second spoke wire mini group are symmetrically arranged around the hub; the first and second spoke wire crosses but not touching each other; and the third and fourth spoke wire crosses but not touching each other.

As a preferred arrangement, the first end of the first and third spoke wire is connected to the first side of the hub; the first and third spoke wire crosses each other in a X shape; the first end of the second and fourth spoke wire is connected to the second side of the hub; and the second and fourth spoke wire crosses each other in a X shape.

As a preferred arrangement, the second end of the first spoke wire is connected to the rim in a position between the second end of second and fifth spoke wire; the distance between the position of the second end of the first and second spoke wire is a first pitch, and the position between the second end of the first and fifth spoke wire is a second pitch; wherein, the first pitch is shorter than the second pitch for better mechanical balance of rim.

### BRIEF DESCRIPTION OF THE DRAWINGS

FIG. 1 is a schematic structural view of preferred embodiment 1 of the present invention.

FIG. 2 is a front view of the implementation of preferred embodiment 1 of the present invention.

FIG. 3 is an illustration of force analysis schematic diagram of the present.

FIG. 4 is a schematic structural view of preferred embodiment 2 of the present invention.

FIG. 5 is a front view of preferred embodiment 2 of the present invention.

### DETAILED DESCRIPTION OF PREFERRED EMBODIMENT

Described below is only the preferred embodiment embodying the principles of the invention and thus does not limit the scope of protection of the present invention.

### Preferred Embodiment 1

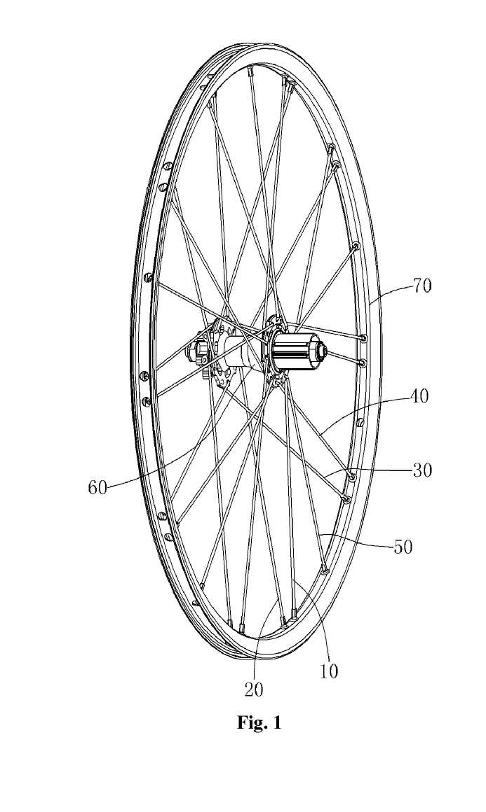

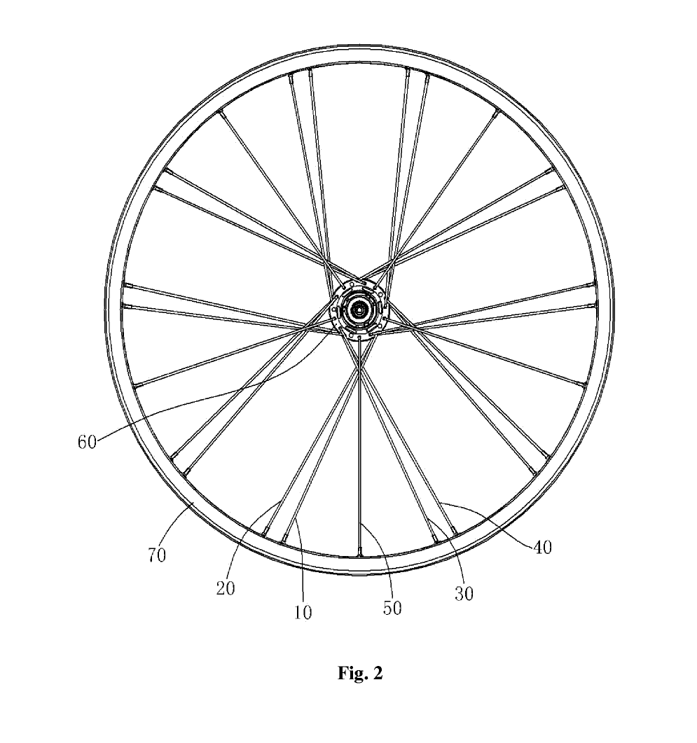

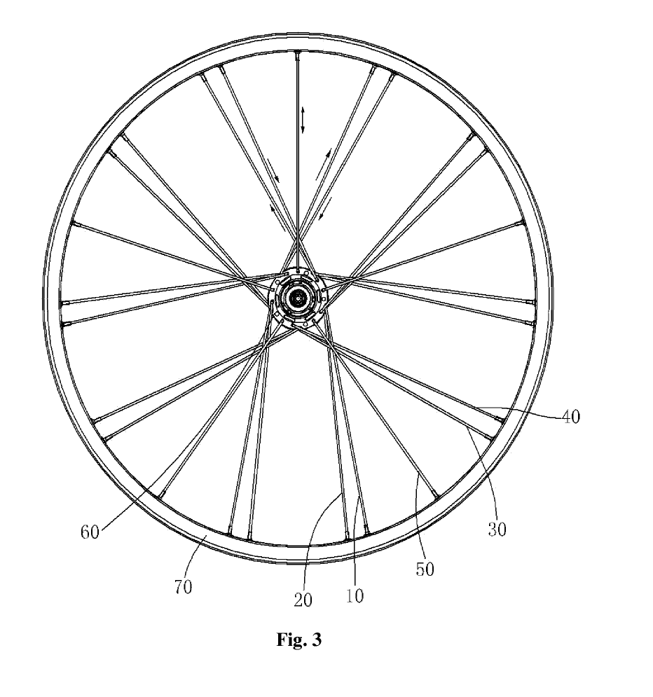

A bicycle wheel structure, as shown in FIG. 1 to FIG. 3, including a hub 60, spoke wires and a rim 70, the drive end of the hub 60 is provided with a drive mechanism, the drive mechanism for the sprocket mechanism, the convergent ends of the spoke wire are respectively connected hub 60 and the rim 70, spoke wires are arranged in a group of five, in a 2:3 interweaving ratio, the hub 60 and the rim 70 are connected to at least three groups of these spoke wires, each of group of the spoke wires 50 are connected circularly along the rim 70.

In the preferred embodiment 1, the hub 60 and the rim 70 are connected to 3˜10 groups of spoke wires. The rim 70 of the present embodiment is illustrated having five groups of spoke wires connecting to it, as shown in FIG. 1 to FIG. 3.

Three spoke wires in the spoke wire group are connected to the hub 60 on its drive end and two spoke wires in the spoke wire group are connected to hub 60 on its non-drive end. With this arrangement, forces are distributed more evenly between each of spoke wire in the spoke wire group. As a result of this arrangement, early failure or pre-mature wear of spoke wires can be minimized, and at same, provide better riding comfort and balance.

In the spoke wire group, a fifth spoke wire 50 works as a force balancer for the other spoke wires in the spoke wire group. The first end of fifth spoke wire 50 is connected to the drive end of the hub, and the second of the fifth spoke wire 50 is connected to the rim 70. The fifth spoke wire 50 is arranged symmetrically in or near the center of the spoke wire group.

The fifth spoke wire 50 is connected to hub 60 and rim 70 in a position that is perpendicularly to the axis of hub 60. With this arrangement the push and pull force of the hub and the rim and be balanced off by the fifth spoke wire 50.

The spoke wire group further comprises a first spoke wire mini group and a second spoke wire mini group. The first end of spoke wires in the first spoke wire mini group is attached to the hub 60 and the second is connected to the rim 70; the first and second spoke wire mini group crosses each other in a X shape; the first end of the fifth spoke wire 50 is arranged in the middle of the first end of first and second spoke wire mini group; and the second end of the fifth spoke wire 50 is arranged in the middle of the second end of first and second spoke wire mini group.

The first spoke wire mini group comprises a first spoke wire 10 and a second spoke wire 20. The first end of the first and second spoke wire 10, 20 is connected to the first and second side of hub 60 respectively. The second end of first and second spoke wire 10, 20 is connected to the rim 70. The second spoke wire mini group comprises a third spoke wire 30 and a fourth spoke wire 40. The first end of the third and fourth spoke wire 30, 40 is connected to the first and second end of hub 60 respectively. The second end of third and fourth spoke wire 30, 40 is connected to the rim 70.

The first spoke wire mini group and second spoke wire mini group are symmetrically arranged around the hub 60; the first and second spoke wire 10, 20 crosses but not touching each other; and the third and fourth spoke wire 30, 40 crosses but not touching each other.

The first end of the first and third spoke wire 10, 30 is connected to the first side of the hub 60; the first and third spoke wire 10, 30 crosses each other in a X shape; the first end of the second and fourth spoke wire 20, 40 is connected to the second side of the hub 60; and the second and fourth spoke wire 20, 40 crosses each other in a X shape.

The second end of the first spoke wire 10 is connected to the rim 70 in a position between the second end of second and fifth spoke wire 20, 50; the distance between the position of the second end of the first and second spoke wire 10, 20 is a first pitch, and the position between the second end of the first and fifth spoke wire 10, 50 is a second pitch; wherein, the first pitch is shorter than the second pitch for better mechanical balance of rim 70.

### Preferred Embodiment 2

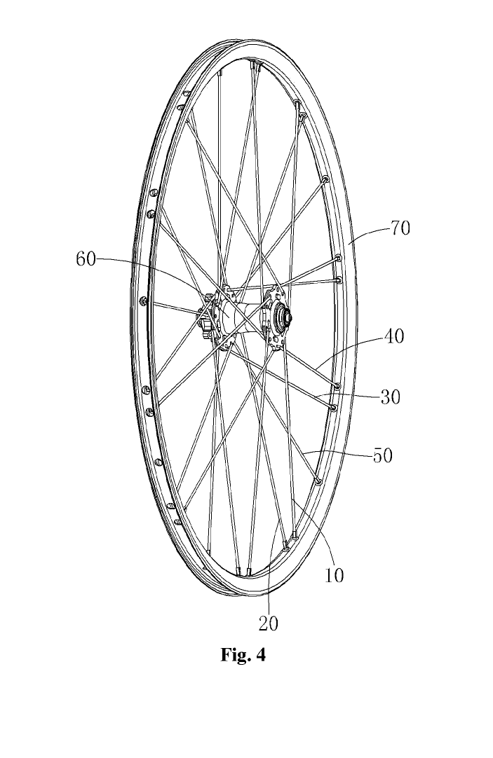

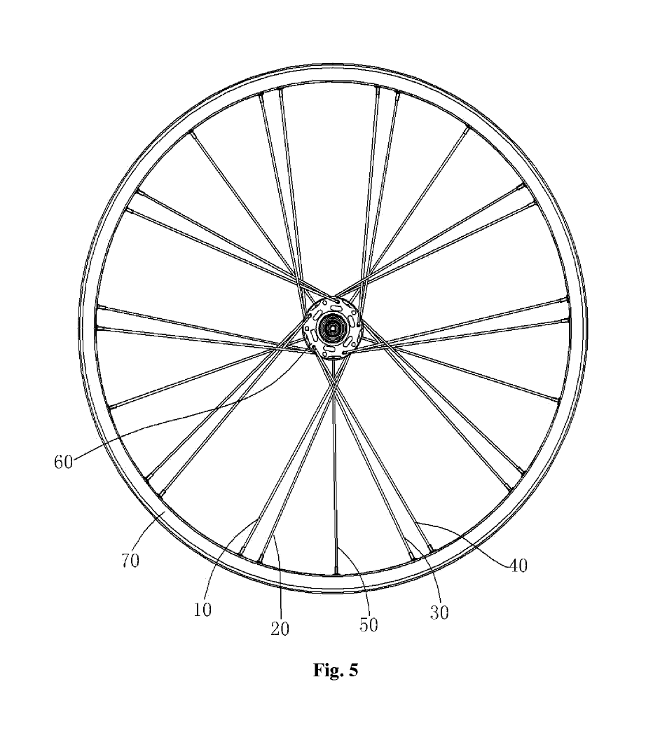

The main structural features of embodiment 2 are the same as Preferred Embodiment 1, which will not be repeated here. The differences, as shown in FIG. 4-5 in that: the drive end of the hub 60 is provided with disc brakes means, rim 70 is provided with five groups of spoke wires, the drive end of the hub 60 is connected to 5 fifth spoke wires 50, and the non-drive end of hub 60 is not connected to any fifth spoke wire 50.

Rim 70 and hub 60, spoke wire, sprocket mechanism and disc brakes device has been widely used, other structures, and the principle is the same with the existing technology, not repeat them here.

1. A bicycle wheel structure comprises a hub, spoke wires and a rim, wherein the front and back end of the spoke wires are connected to the hub and the rim respectively, wherein: spoke wires are arranged in a group of five spoke wires to form a spoke wire group, wherein each spoke wire group has an interweaving spoke wire ratio of 2:3, and the hub and the rim are connected to at least three groups of the spoke wire group.

2. The bicycle wheel structure as claimed in claim 1 wherein, said hub and rim connect to 3˜10 groups of spoke wire group, the spoke wire groups connect to the rim circularly along the rim.

3. The bicycle rim structure as claimed in claim 1 wherein, said three of the spoke wires in the spoke wire group connected to the driving end of the hub and two of the spoke wires in the spoke wire group connected to the non-driven end of the hub.

4. The bicycle wheel structure as claimed in claim 1 wherein, said spoke wire group comprise a fifth spoke wire that works as a force balancing wire for the other four spoke wires, wherein, the first end of the fifth spoke wire is connected to the driving end of the hub, and the second end of the fifth spoke wire is connected to the rim; and said fifth spoke wire is arranged symmetrically in, or near the center of the spoke wire group.

5. The bicycle wheel structure as claimed in claim 4 wherein, said fifth spoke wire is disposed within a plane passing through the axis of the hub or the rim.

6. The bicycle wheel structure as claimed in claim 4 wherein, said spoke wire group comprises a first spoke wire mini group and a second spoke wire mini group, wherein, the first end of the first spoke wire mini group connected to the hub, and the second of end of the first spoke wire mini group terminal is connected to the rim; the first end of the second spoke wire mini group connected to the hub, and the second of end of the second spoke wire mini group terminal is connected to the rim; the first and second spoke wire mini groups cross each other; the first end of said fifth spoke wire is arranged in, or symmetrically in, the center between the first end of said first spoke wire mini group and the first end of said second spoke wire mini group; the second end of said fifth spoke wire is arranged in, or symmetrically in, the center between the second end of said first spoke wire mini group and the second end of said second spoke wire mini group.

7. The bicycle wheel structure as claimed in claim 6 wherein, said first spoke wire mini group comprises a first spoke wire and a second spoke wire; wherein the first end of the first and second spoke wire is connected to a first and a second side of the hub; wherein, the second end of the first and second spoke wire is connected to the rim; wherein, said second spoke wire mini group comprises a third and fourth spoke wire; wherein, the first end of said third and fourth spoke wire is connected to a first and a second side of the hub; wherein, the second end of the third and fourth spoke wire is connected to the rim.

8. The bicycle wheel structure as claimed in claim 7 wherein, said first spoke wire mini group and second spoke wire mini group are symmetrically arranged around the hub; furthermore, it is characterized that: said first and second spoke wire crosses but not touching each other, and said third and fourth spoke wire crosses but not touching each other.

9. The bicycle wheel structure as claimed in claim 7 wherein, said first end of the first and third spoke wire is connected to the first side of the hub; said first spoke wire and third spoke wire crosses each other; said first end of the second and fourth spoke wire is connected to the second side of the hub; and said second and fourth spoke wire crosses each other.

10. The bicycle wheel structure as claimed in claim 7 wherein, said second end of the first spoke wire is connected to the rim in a position between the second end of the second and fifth spoke wire; it is characterized that the distance between the position of the second end of the first and second spoke wire is a first pitch, and the position between the second end of the first and fifth spoke wire is a second pitch; wherein, the first pitch is shorter than the second pitch.
